(19) United States
(12) Patent Application Publication
(10) Pub. No.: US 2005/0079402 A1
(43) Pub. Date: Apr. 14, 2005

(54) Fuel cell

(75) Inventors: Aoi Tanaka, Osaka (JP); Yukihiro Okada, Osaka (JP); Satoshi Shibutani, Osaka (JP); Nobuhiko Hojo, Osaka (JP); Teruhisa Kanbara, Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Matsushita Electric Industrial Co., Ltd.

(21) Appl. No.: 10/940,874

(22) Filed: Sep. 14, 2004

Related U.S. Application Data
(63) Continuation of application No. PCT/JP03/03393, filed on Mar. 20, 2003.

(30) Foreign Application Priority Data
Mar. 20, 2002 (JP) 2002-078369

(51) Int. Cl. H01M 4/86; H01M 8/10; H01M 4/90; H01M 4/92

(52) U.S. Cl. 429/40; 429/30; 429/42; 429/44

(57) ABSTRACT

A fuel cell includes a catalysis layer constituting a fuel supply side electrode. The catalysis layer includes a catalyst, an electrically conductive substance, a hydrogen ion-conductive electrolytic substance, and a carbon monoxide oxidizer. As the carbon monoxide oxidizer, for example, particles of a transition metal oxide, chloride, or hydride are used. Alternatively, a metal complex containing water as a ligand can also be used as the carbon monoxide oxidizer.

### CROSS-REFERENCE TO RELATED APPLICATIONS

This application is a continuation of International Application No. PCT/JP03/03393, filed Mar. 20, 2003, the disclosure of which is incorporated herein by reference.

### BACKGROUND OF THE INVENTION

This invention generally relates to fuel cells and, more particularly, to fuel cells of the polymer electrolyte (“polyelectrolyte”) membrane type which directly use, as the fuel, a liquid fuel containing an organic compound such as methanol, ethanol, dimethylether, etc., and which use, as the oxidizer, air or oxygen. More specifically, the present invention relates to a fuel supply side electrode of such a type of fuel cell.

In typical polyelectrolyte type fuel cells, a fuel capable of generating protons, such as hydrogen, is supplied to a fuel electrode, and an oxygen-containing oxidizer (oxidant), such as air, is supplied to an oxidant electrode. The fuel and the oxidant undergo electrochemical reaction to produce electricity. In this type of fuel cell, one surface of a polyelectrolyte membrane capable of selective hydrogen ion transport is provided with a fuel supply side electrode and the other surface is provided with an oxidant side electrode. In formation of these electrodes, a catalytic reaction layer, composed of a mixture of either electrically conductive carbon particles on which a metal catalyst is supported or a simple metal catalyst substance and a hydrogen ion-conductive polyelectrolyte, is first formed on each surface of the polyelectrolyte membrane. Thereafter, a diffusion layer composed of a material (e.g., electrically conductive carbon particle paper), which permits the fuel or oxidant gas to pass therethrough and has the property of conducting electrons, is placed on an outer surface of each catalytic reaction layer. The combination of the catalytic reaction layer and the diffusion layer formed on each surface of the polyelectrolyte membrane is called an electrode.

In addition, gas sealing members, gaskets or the like are disposed in fuel cells around the electrodes with the polyelectrolyte membrane held therebetween, so as to prevent the fuel and oxidant gas supplied to the respective electrodes from leaking out and mixing with each other. The gas sealing members or gaskets are formed integrally with the electrodes and with the polyelectrolyte membrane, and such an integrated body is called a membrane electrode assembly (hereinafter referred to as “MEA”).

Generally, the catalytic reaction (“catalysis”) layer of the polyelectrolyte type fuel cell is formed by shaping a mixture of electrically conductive carbon fine particle powders, on which a precious metal catalyst of the platinum group is supported, and a hydrogen ion-conductive polyelectrolyte into a thin layer. Currently, as the hydrogen ion-conductive polyelectrolyte, perfluorocarbon sulfonic acid is usually used. There are several methods of forming a catalysis layer. For example, in a catalysis layer forming method, electrically conductive carbon fine particle powders supporting a catalyst thereon are mixed with a polyelectrolyte solution prepared by dissolving a hydrogen ion-conductive polyelectrolyte in an alcohol solvent, such as ethanol. This mixture is doped with an organic solvent having a relatively high boiling point, such as isopropyl alcohol, butyl alcohol or the like for conversion into an ink-like fluid. This ink is applied onto a polyelectrolyte membrane by means of a screen print, spray coat, doctor blade, roll coater, or similar process.

When generating electricity by means of a fuel cell of the type which directly uses, as its fuel, an organic fuel such as methanol, the organic fuel is oxidized and generation of CO₂ is inevitable, unlike the case where hydrogen is used as the fuel. Here, since the oxidation reaction of an organic fuel is lower in reaction efficiency than the oxidation of hydrogen, the organic fuel will not be totally oxidized to CO₂ in the catalysis layer of the fuel supply side electrode, which may result in generation of intermediate products such as CO, COH, HCHO, HCOOH (hereinafter referred to generically as “CO-type compounds” or more simply “CO compounds”). The generation of CO compounds has a number of drawbacks discussed below.

In a catalysis layer constituting an electrode, metals of the platinum group are widely used as a catalyst, as described above. Among them, platinum is a favorable catalyst. Platinum is a member of the group X transition metals, which means that the existence of a CO compound creates a back donation bond between the d orbital of platinum in which no electron exists and the p* orbital of CO. Such a bond is strong, and once a CO compound is coordinated on platinum, it is difficult to remove it therefrom. As a result of adsorption of such a CO compound, there occurs catalyst poisoning, thereby causing a reduction in the effective electrode area. The voltage of the fuel cell falls accordingly. Furthermore, in an oxidation reaction, which generates a CO compound, the oxidation of the organic fuel terminates at an intermediate stage, such as 2-electron oxidation and 4-electron oxidation, thereby causing a reduction in the organic fuel oxidation efficiency. Therefore, the electricity producing capability of the fuel cell drops.

As a typical method of preventing the occurrence of catalyst poisoning caused by CO compounds, there is a technique employing a catalyst which is an alloy formed by mixing platinum and ruthenium at a mixing ratio of 1:1 (i.e., Pt:Ru=1:1). It is believed that the catalyst is regenerated by this technique, because a CO compound, bonded onto the platinum as described above, is oxidized by OH₂ seeds coordinated in the ruthenium. Additionally, there are other alloying techniques employing metals other than ruthenium. In other alloying techniques, tin, molybdenum, or tungsten are alloyed with platinum (see, for example, M. Gotz and H. Wendt, “Binary and ternary anode catalyst formulations including the elements W, Sn and Mo for PEMFCs operated on reformate gas,” Electrochim. Acta, 43(24): 3637-3644 (1988). In another alloying technique, a rare earth element and platinum are alloyed (see, for example, Japanese Patent Publication (Kokai) No. 1998-162839) and Japanese Patent Publication (Kokai) No. 1998-255831).

As has been described above, in order to reduce catalyst poisoning, a catalyst composed of an alloy of platinum and ruthenium or composed of an alloy of platinum and another precious metal element is used with a view to achieving improvement in the methanol oxidizing activity. However, this technique has difficulties in providing satisfactory poisoning prevention, and the improvement in oxidation activity of an organic fuel by this technique is not always satisfactory. Additionally, in a fuel cell using an organic fuel, CO₂ is inevitably generated on the fuel supply side by oxidation of the fuel, and if the CO₂ gas thus generated is not discharged immediately to outside the electrode, this may present several problems. One problem is that both the catalyst and the fuel pathway inside the electrode are covered with CO₂ gas. Another problem is that the fuel and the oxidant gas, which are supplied to the fuel cell, are mixed with CO₂ gas. As a result, there is a drop not only in effective catalyst reaction area but also in fuel diffusiblity. The voltage of the fuel cell falls accordingly.

On the other hand, even in the case of fuel cells of the type using hydrogen, there is the possibility that CO gas, contained in a hydrogen gas generated in a hydrogen generator of the fuel cell system and supplied to the fuel cell, forms a bond as described above between the catalyst and the CO gas. As a result, the catalyst is poisoned by the CO gas. Furthermore, even when CO is oxidized to CO₂, the above-described problems will arise unless discharge of CO₂ gas is carried out promptly.

### BRIEF SUMMARY OF THE INVENTION

Accordingly, an object of the present invention is to provide a fuel cell capable of achieving efficient oxidative conversion of a CO compound, adsorbed onto a catalysis layer constituting an electrode, into CO₂ and capable of efficient discharge of the generated CO₂ from the catalysis layer. Therefore, the fuel cell of the present invention should perform the fuel oxidation with high efficiency and carry out satisfactory generation of electricity.

In order to achieve the above-mentioned objects, the present invention provides a fuel cell comprising a hydrogen ion-conductive electrolyte membrane, a first electrode disposed on one surface of the hydrogen ion-conductive electrolyte membrane, a second electrode disposed on the other surface of the hydrogen ion-conductive electrolyte membrane, wherein the first and second electrodes include respective catalysis parts, wherein a fuel is supplied to the first electrode and an oxidant is supplied to the second electrode, and wherein electricity is produced by oxidation of the fuel. In the fuel cell, at least the catalysis part of the first electrode includes: a catalyst which participates in the fuel oxidation; an electrically conductive substance which constitutes a pathway for electrons generated by the fuel oxidation; a hydrogen ion-conductive electrolyte substance which constitutes a pathway for hydrogen ions generated by the fuel oxidation; and a carbon monoxide oxidizer for oxidizing a CO compound generated in the fuel oxidation.

In the above-described arrangement, since the catalysis part of the first electrode, which is supplied with a fuel, contains a carbon monoxide oxidizer, this makes it possible to oxidize the CO compound, generated by fuel oxidation taking place in the catalysis part and causing catalyst poisoning, to carbon dioxide by the carbon monoxide oxidizer. Accordingly, occurrence of the catalyst poisoning is prevented, thereby making it possible to achieve improvement in the fuel oxidation efficiency. Therefore, in a fuel cell provided with such a first electrode, it becomes possible to achieve improvements in the production of electricity.

The catalyst of the catalysis part of the invention may comprise at least one metal element selected from the group of platinum, ruthenium, palladium, nickel, rhodium, cobalt, iridium, osmium, and iron. For example, the catalyst may be a simple metal substance, a metal compound, or an alloy.

In accordance with such arrangement, the supplied fuel is oxidized by the action of the catalyst, and electricity is produced by the oxidation.

The electrically conductive substance of the catalysis part of the invention may comprise carbon black, carbon particles, metal fine particles, or electrically conductive polymers.

As a result of such arrangement, the conduction or transport of electrons generated in a fuel oxidation is satisfactory, and the efficiency of reaction is sufficient, thereby realizing satisfactory generation of electricity.

The hydrogen ion-conductive electrolyte substance used in the catalysis part of the invention may be a polyelectrolyte substance. Preferably, the hydrogen ion-conductive electrolyte substance contains a fluorocarbon in its main chain.

As a result of such arrangement, the conduction of hydrogen ions generated in a fuel oxidation is improved, and the efficiency of reaction is satisfactory, thereby realizing satisfactory generation of electricity.

The carbon monoxide oxidizer in the catalysis part of the invention is preferably granular (particulate) and may contain any one or more of a metal compound, such as metal oxide, metal chloride, or metal hydride; a metal compound having hydrated water; an organic substance; and/or a metal complex containing water as a ligand.

By virtue of such arrangement, the CO compound adsorbed onto the catalyst is oxidized to carbon dioxide for desorption of the CO compound from the catalyst. Therefore, the prevention of occurrence of catalyst poisoning is realized.

The metal oxide of the oxidizer may be partially crystalline. Alternatively, the metal oxide may be entirely crystalline.

As a result of such arrangement, a CO compound adsorbed onto the catalyst is oxidized efficiently, and carbon dioxide generated in the oxidation is discharged promptly from the catalysis part.

The carbon monoxide oxidizer may be arranged such that it overlies the electrically conductive substance. Alternatively, the carbon monoxide oxidizer may overlie the catalyst. As another alternative, the carbon monoxide oxidizer may constitute a mixture together with the catalyst.

It is preferred that the carbon monoxide oxidizer have a particle (granule) size of not less than about one time nor more than about 100 times the particle size of the catalyst.

As a result of such arrangement, a CO compound adsorbed onto the catalyst is oxidized efficiently, and carbon dioxide generated in the oxidation is discharged promptly from the catalysis part. Hereby, the fuel cell is improved in electricity producing performance.

It is preferred according to the invention that the ratio F/C be not less than about 0.01 nor more than about 2, where F denotes the weight of the hydrogen ion-conductive electrolyte substance and C denotes the weight of the electrically conductive substance.

As a result of such arrangement, fuel oxidation by the catalyst takes place efficiently, and diffusion of fuel, carbon dioxide, etc. takes place efficiently in the catalysis part. Hereby, the fuel cell is improved in its electricity producing performance.

It is preferred that the ratio M/C be not less than about 0.01 nor more than about 0.5, where M denotes the weight of the carbon monoxide oxidizer and C denotes the weight of the electrically conductive substance.

As a result of such arrangement, a CO compound adsorbed onto the catalyst in the catalysis part is oxidized efficiently and, in addition, efficient movement of electrons, hydrogen ions, and fuel is realized in the catalysis part. Hereby, the fuel cell is improved in electricity producing performance.

The fuel used in the invention is an organic compound. For example, the fuel may be formed of methanol, ethanol, ethylene glycol, dimethylether, dimethoxymethane, or a mixture of two or more different kinds of these organic compounds.

By virtue of such arrangement, it becomes possible to directly supply an organic compound as a fuel, thereby eliminating the need for the provision of a hydrogen generator or the like for generating hydrogen for supply to the fuel cell. The size of fuel cell system is thereby reduced, and a reduction in production costs is achieved. Here, in the case where an organic compound is directly supplied as a fuel, the effective performance of the present invention is achieved, because generation of a CO compound takes place on the fuel electrode side.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is an exploded schematic perspective illustration of an arrangement of a fuel cell according to one embodiment of the present invention, showing here unit cell;

FIGS. 2A and 2B are schematic diagrams of an arrangement of a membrane electrode assembly (MEA) of FIG. 1, wherein FIG. 2A is a schematic top plan view of the MEA, and FIG. 2B is a cross sectional side view of the MEA;

FIG. 3 is a cross sectional side view showing an arrangement of a fuel cell according to one embodiment of the present invention, illustrating here a stack construction comprising a lamination of unit cells shown in FIG. 1;

FIG. 4 is a graph showing the discharge characteristics of the fuel cell according to Example 1;

FIG. 5 is a table showing the discharge characteristics of the fuel cell according to Example 2;

FIG. 6 is a graph showing the discharge characteristics of the fuel cell according to Example 2;

FIG. 7 is a table showing the discharge characteristics of the fuel cell according to Example 3;

FIG. 8 is a graph showing the discharge characteristics of the fuel cell according to Example 3;

FIG. 9 is a table showing the discharge characteristics of the fuel cell according to Example 4;

FIG. 10 is a graph showing the discharge characteristics of the fuel cell according to Example 4;

FIG. 11 is a table showing the discharge characteristics of fuel cells according to Examples 5 to 8; and

FIG. 12 is a graph showing the discharge characteristics of the fuel cells according to Examples 5 to 8.

### DETAILED DESCRIPTION OF THE INVENTION

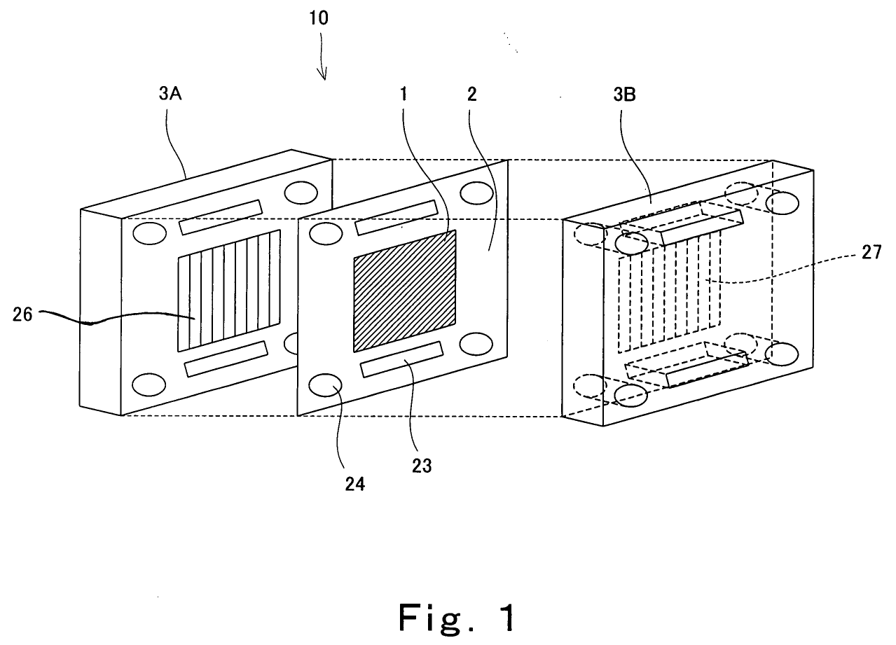

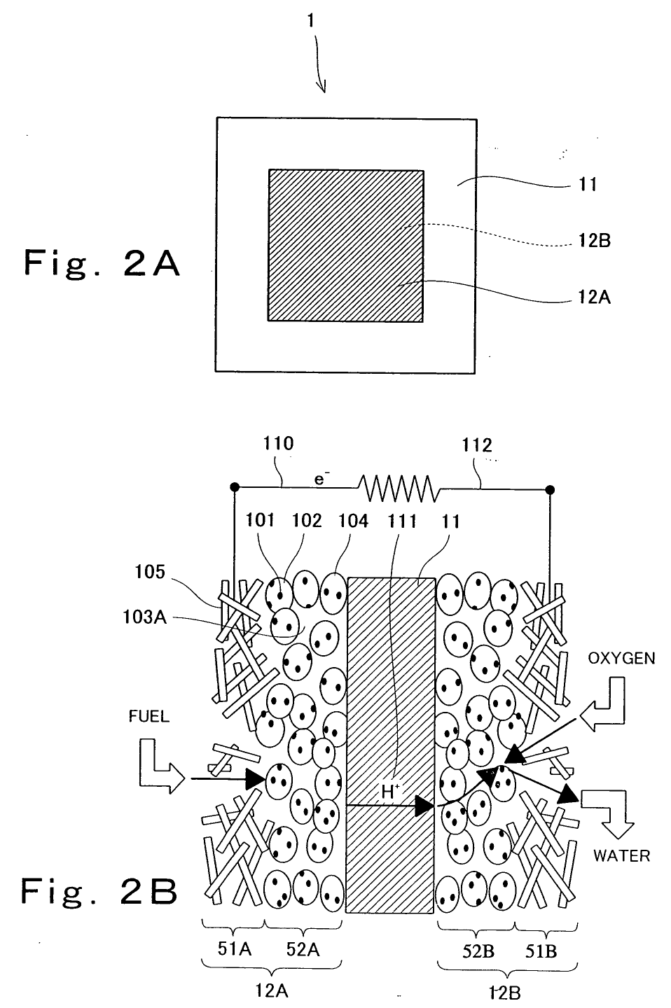

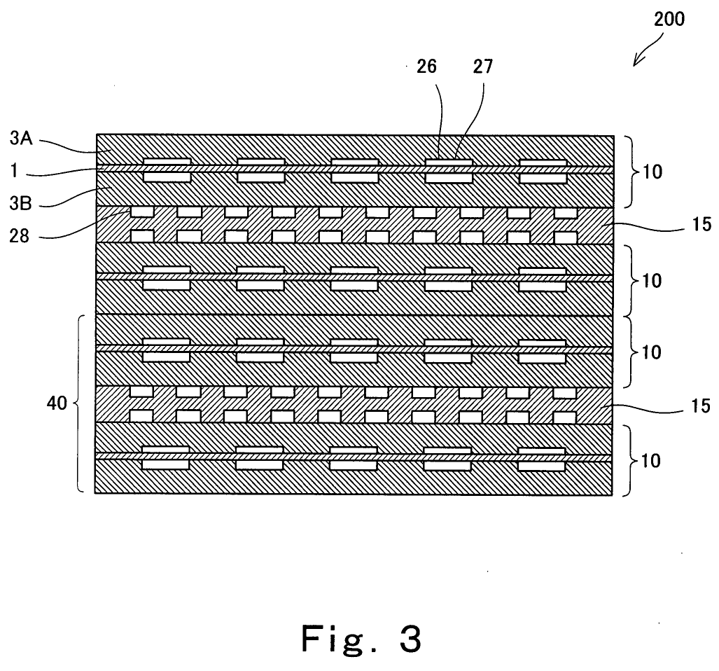

FIG. 1 is a perspective illustration schematically showing an arrangement of a fuel cell in accordance with one embodiment of the present invention. More specifically, FIG. 1 shows an electric cell (hereinafter called “cell unit”). In addition, FIG. 2, comprised of FIGS. 2A and 2B, is a schematic illustration showing an arrangement of a membrane electrode assembly (hereinafter “MEA”) for use in the cell unit of FIG. 1, wherein FIG. 2A is a schematic top plan view of the MEA and FIG. 2B is a schematic cross sectional side view of the MEA. Furthermore, FIG. 3 is a schematic cross sectional side view depicting an arrangement of a fuel cell formed of a lamination of a plurality of cell units shown in FIG. 1 (hereinafter called “fuel cell stack”).

As shown in FIG. 1 and FIGS. 2A and 2B, in a cell unit 10 of a solid polyelectrolyte type fuel cell of the present embodiment, a gasket plate 2 is joined to the outer periphery of an MEA 1 comprising a hydrogen ion-conductive polyelectrolyte membrane 11. A pair of electrodes 12A, 12B is disposed on opposite surfaces of the MEA 1, so that they face each other across the MEA 1. A pair of separators 3A, 3B is so disposed as to face each other across the gasket plate 2. Although not represented diagrammatically here, a current collecting plate and an insulating plate, composed of an electrical insulating material, are provided at ends of the cell unit 10, and the entire body is fastened by end plates and fastening rods to form the cell unit 10.

Manifold apertures 24 for fuel and oxidant distribution and manifold apertures 23 for cooling water distribution are formed through the gasket plate 2 and the separators 3A, 3B. Additionally, fuel flow paths 26, which comprise grooves formed in an inner surface of the separator 3A (i.e., an opposing surface of the separator 3A to the MEA 1), are provided in the separator 3A. Oxidant flow paths 27, which comprise grooves formed in an inner surface of the separator 3B (i.e., an opposing surface of the separator 3B to the MEA 1), are provided in the separator 3B. Although not represented diagrammatically here, the manifold apertures 24 of the separator 3A are connected to a fuel supply line which is laid outside, and a supply of fuel is provided to the fuel flow paths 26 via the manifold apertures 24. On the other hand, the manifold apertures 24 of the separator 3B are connected to an oxidant supply line which is laid outside, and a supply of oxidant is provided to the oxidant flow paths 27 via the manifold apertures 24. As can be seen from FIG. 3, a cooling plate 15, provided with grooves which comprise cooling water flow paths 28 in each surface thereof, is arranged between a pair of cell units 10 to form a stack construction unit 40. A plurality of such stack construction units 40 are laminated together to form a fuel cell stack 200.

Referring to FIG. 2, the hydrogen ion-conductive polyelectrolyte membrane 11 constituting the central part of the MEA 1 is formed by an ion exchange membrane capable of selective transport of hydrogen ions 111 from fuel supply side to oxidant supply side. A fuel supply side electrode (hereinafter called “fuel electrode”) 12A is formed over one surface of the polyelectrolyte membrane 11 except for its edge areas, and an oxidant supply side electrode (hereinafter called “oxidant electrode”) 12B is formed over the other surface of the polyelectrolyte membrane 11 except for its edge areas. The fuel electrode 12A is made up of a catalysis layer 52A and a diffusion layer 51A. The oxidant electrode 12B is made up of a catalysis layer 52B and a diffusion layer 51B. The catalysis layers 52A, 52B are formed on the opposite surfaces of the polyelectrolyte membrane 11, respectively. On the other hand, the diffusion layers 51A, 51B are formed on outer surfaces of the catalysis layers 52A, 52B, respectively.

As will be described later, when the fuel cell is in operation, an organic fuel is supplied to the fuel electrode 12A and an oxidant gas is supplied to the oxidant electrode 12B. Therefore, it is the fuel electrode 12A that mainly comes under the influence of the generation of a CO compound and CO₂ gas. In view of this, the structure of the fuel electrode 12A will be described in detail hereinafter. The structure of the oxidant electrode 12B may be the same as that of the fuel electrode 12A. Alternatively, the oxidant electrode 12B may be different in structure from the fuel electrode 12A, having the same structure as conventional oxidant electrodes. Here, the oxidant electrode 12B has the same structure as the fuel electrode 12A, with the exception that the catalysis layer 52B does not contain a carbon monoxide oxidizer 104.

The catalysis layer 52A of the fuel electrode 12A includes a catalyst 101, an electrically conductive substance 102, a hydrogen ion-conductive electrolyte substance (not shown), and a carbon monoxide oxidizer 104. Fine pores 103A, which serve as flow paths through which the supplied fuel and generated CO₂ gas flow, are formed in the catalysis layer 52A. Hereinafter, each structural element of the catalysis layer 52A will be described. FIG. 2B is schematic diagram showing a highly simplified representation of an arrangement of the catalysis layer 52A. It should be noted that the shape and size of each structural element, the layout state, the content ratio, etc. are not limited to those of the present embodiment shown in the Figures.

The catalyst 101 is a metal catalyst containing at least one metal element, such as platinum, ruthenium, palladium, nickel, rhodium, cobalt, iridium, osmium, iron, etc. For example, either a simple metal substance selected from among the aforesaid metal elements or a metal compound containing one or more of the aforesaid metal elements may be used as the catalyst 101. Alternatively, an alloy containing two or more different kinds of the aforesaid metal elements may be used as the catalyst 101. The state containing such a plurality of metal elements may be either in the form of a mixture or in the form of a solid solution, and additionally, may be entirely or partially alloyed. It is especially preferable that the catalyst 101 be formed of an alloy of platinum and ruthenium. This not only reduces adsorption of a CO compound onto the catalyst 101, but also prevents catalyst poisoning.

The electrically conductive substance 102 is provided to support the catalyst 101, and comprises for example carbon black, carbon particles, metal fine particles, or electrically conductive polymers.

The hydrogen ion-conductive electrolyte substance is composed of a polyelectrolyte substance. It is especially preferable that the hydrogen ion-conductive electrolyte substance contain fluorocarbon in its main chain. For example, electrically conductive particle perfluorocarbon sulfonic acid or the like may be used as the hydrogen ion-conductive electrolyte substance.

The carbon monoxide oxidizer 104 may comprise a metal compound such as metal oxide, metal chloride, and metal hydride. Alternatively, the carbon monoxide oxidizer 104 may comprise a metal compound having hydrated water. As further alternatives, the carbon monoxide oxidizer 104 may comprise either an organic substance or a metal complex containing water as a ligand. Hereinafter, specific examples will be described.

As the metal oxide, for example, transition metal oxides are used. It is especially preferable to use oxides of transition metals of the groups III to XIV. Especially, metal oxides of manganese, copper, cobalt, nickel, chromium, germanium, vanadium, tin, silver, iron, and tungsten are used. More specifically, either a transition metal oxide (e.g., MnO₂, CuO, Co₃O₄, NiO, Cr₂O₃, GeO₂, V₂O₅, SnO₂, AgO, Fe₂O₂ etc.) or a composite oxide containing two or more different kinds of these transition metal oxides may be used.

Here, preferably these metal oxides are at least partially crystalline. If the whole of such a metal oxide is amorphous, this causes strong adsorption of water, which participates in oxidation of a CO compound onto to the surface of the metal oxide. Although it is required that the water be moved to the CO compound for oxidizing the CO compound into CO₂, the water may be unavailable for the CO oxidation because of such a strong adsorbability. This results in a drop in the capability of oxidizing a CO compound. Moreover, if a metal oxide is entirely amorphous, its surface wettability increases. As the result of this, CO₂ gas generated by oxidation of a CO compound is not discharged promptly from the catalysis layer. Therefore, it is highly likely that the foregoing problems will arise. In view of this, the provision of a metal oxide which is at least partially (more preferably entirely) crystalline achieves not only improvement in the capability of oxidizing a CO compound, but also improvement in the efficiency of discharging CO₂ gas.

As the metal chloride, for example, transition metal chlorides are used. Especially, metal chlorides of titanium, vanadium, chromium, manganese, iron, cobalt, nickel, copper, zinc, molybdenum, ruthenium, silver, tungsten, iridium, etc. are used. More specifically, either a metal chloride (such as TiCl₄, VCl₄, CrCl₃, MnCl₂, FeCl₂, CoCl₂, NiCl₂, CuCl₂, ZnCl₂, ZrCl₄, NbCl₅, MoCl₅, RuCl₃, AgCl, WCl₅, IrCl₃, etc.) or a composite chloride containing two or more different kinds of these metal chlorides may be used.

As the metal hydride, for example, transition metal hydrides are used. More specifically, either a metal hydride of the group XII, XIII, or XIV transition metals or its composite hydride may be used.

As the metal complex containing water as a ligand, RuCp*(OH₂)₃, IrCp*(OH₂)₃, or the like may be used, where “Cp*” represents a pentamethylcyclopentadienyl.

The carbon monoxide oxidizer 104 may overlie the electrically conductive substance 102 supporting the catalyst 101 thereon. Alternatively, the carbon monoxide oxidizer 104 may overlie the catalyst 101. The carbon monoxide oxidizer 104 may also exist in such a state as to form a mixture together with the catalyst 101. The carbon monoxide oxidizer 104 of this type may be mixed with the catalyst 101 and the electrically conductive substance 102 by dry or wet blending during formation of the catalysis layer 52A. Furthermore, the carbon monoxide oxidizer 104 may be formed integrally with the catalyst 101 and the electrically conductive substance 102 by means of coating, spraying, deposition, electroplating, chemical plating, sputtering, vacuum deposition, or the like.

Because of its strong oxidation power to the substance to be oxidized, the carbon monoxide oxidizer 104 is able to oxidize a CO compound adsorbed onto the catalyst 101 of the fuel electrode 12A and to facilitate desorption of the compound from the catalyst 101. For example, in the case where the carbon monoxide oxidizer 104 comprising either a metal oxide (such as MnO₂, CuO, Co₃O₄, NiO, Cr₂O₃, GeO₂, V₂O₅, SnO₂, AgO, Fe₂O₂ etc.) or a composite oxide containing two or more different kinds of these metal oxides is used, these metal oxides are weak in metal-oxygen bonding. Therefore, their oxidation power to the substance to be oxidized by oxygen ion is strong. As a result, it becomes possible to oxidize a CO compound adsorbed onto the catalyst 101 and desorb it from the catalyst 101. This prevents poisoning of the fuel electrode 12A caused by the CO compound.

Here, it is preferable that the carbon monoxide oxidizer 104 have a particle size of not less than about one time nor more than about 100 times the particle size of the catalyst 101. If the particle size of the carbon monoxide oxidizer 104 is less than about one time that of the catalyst 101, in other words, if the particle size of the carbon monoxide oxidizer 104 is smaller than that of the catalyst 101, this increases the area of contact between a CO compound and the carbon monoxide oxidizer 104, thereby achieving effective oxidation of the CO compound. In this case, however, the fine pore 103A of the catalysis layer 52A which consists of a gas flow path is stopped up by particles of the carbon monoxide oxidizer 104, and gas diffusiblity becomes insufficient, thereby making it difficult to assure a diffusion pathway for CO₂ generated by oxidation of the CO compound. Therefore, it becomes difficult to discharge CO₂ from the catalysis layer 52A. If such a CO₂ gas is not discharged immediately from inside the catalysis layer 52A, this causes a drop in velocity at which fuel is supplied to the catalyst 101. On the other hand, if the particle size of the carbon monoxide oxidizer 104 is more than about 100 times the particle size of the catalyst 101, it is difficult to oxidize a CO compound adsorbed onto the catalyst 101 because the area of contact between the CO compound and the carbon monoxide oxidizer 104 is narrow. In view of this, in order to effectively achieve oxidation of the CO compound and to immediately discharge CO₂ generated by the CO compound oxidation to the outside, it is preferable that the particle size of the carbon monoxide oxidizer 104 fall within the aforesaid range.

Additionally, preferably the ratio of M/C, where M is the weight of the carbon monoxide oxidizer 104 of the catalysis layer 52A and C is the weight of the electrically conductive substance 102 of the catalysis layer 52A, ranges between about 0.01 and 0.5. If the M/C ratio is less than about 0.01, i.e., if the ratio of the carbon monoxide oxidizer 104 is small, this makes it difficult to establish sufficient contact between the carbon monoxide oxidizer 104 and the catalyst 101. Therefore, the carbon monoxide oxidizer 104 becomes insufficient in the function of oxidizing a CO compound adsorbed onto the catalyst 101. On the other hand, if the M/C ratio is greater than about 0.5, i.e., if the ratio of the carbon monoxide oxidizer 104 is great, the organic fuel and hydrogen ion-conduction pathways become obstructed and, because of the fact that the carbon monoxide oxidizer 104 is lower in electron conductivity than the electrically conductive substance 102, the electron conductivity of the catalysis layer 52A falls, and the resistance of the catalysis layer 52A increases. This results in a drop in fuel cell output.

Furthermore, preferably the ratio of F/C, where F is the weight of the hydrogen ion-conductive electrolyte substance of the catalysis layer 52A and C is the weight of the electrically conductive substance 102 of the catalysis layer 52A, ranges between about 0.01 and 2. In the fuel cell, it is important to secure an organic fuel supply pathway, a hydrogen ion-conducting pathway, and an electron-conducting pathway in the catalysis layer 52A of the fuel electrode 12A. In addition, the electricity producing performance of the fuel cell depends greatly upon the area of interface among these pathways, i.e., the area of three-phase interface among the fine pores 103A which becomes an organic fuel supply pathway, the hydrogen ion-conductive electrolyte substance which becomes a hydrogen ion-conducting pathway, and the electrically conductive substance 102 which becomes an electron-conducting pathway. As the three-phase interface area increases, the output of the fuel cell is improved. Accordingly, when the F/C ratio is less than about 0.01, the area of interface defined between the hydrogen ion-conductive electrolyte substance and the electrically conductive substance 102 diminishes, which is a disadvantage at the time of generation of electricity in which the density of electric current is great. Furthermore, when the F/C ratio exceeds about 2, the organic fuel supply pathway and the reaction gas pathway are blocked up by the hydrogen ion-conductive electrolyte substance, and the diffusion rate of them thereby controls the generation of electricity. Consequently, the fuel cell output will drop, especially in a range of great electrical current density. In view of the above, it is preferable that the F/C ratio ranges between about 0.01 and 2. This makes it possible to achieve improvement in electricity producing performance of the fuel cell.

In the fuel electrode 12A, the diffusion layer 51A is formed on an outer surface of the catalysis layer 52A composed of the aforementioned elements. The diffusion layer 51A is made of an electron-conductive material capable of permitting flow of an organic fuel therethrough, such as electrically conductive carbon particle paper, e.g., cloth made of electrically conductive carbon fibers 105. The diffusion layer 51A of the fuel electrode 12A and the diffusion layer 51B of the oxidant electrode 12B are placed one upon the other so that they face each other across the hydrogen ion-conductive polyelectrolyte membrane 11, and are joined by fusion bonding. Hereby, the MEA 1, formed by combining the electrodes 12A, 12B and the electrolyte membrane 11 into one united body, is provided.

In operation of the fuel cell, an organic fuel is introduced, through the manifold apertures 24 of the separator 3A, into the fuel supply flow path 26 from a fuel supply line (not shown). As the organic fuel, an organic compound (such as methanol, ethanol, ethylene glycol, dimethylether, dimethylmethane, dimethoxyethane, etc.), a mixture containing such an organic compound, or the like may be used. Here, for example, methanol is used as the organic fuel. On the other hand, an oxidant is introduced, through the manifold apertures 24 of the separator 3B, into the oxidant supply flow path 27 from an oxidant supply line (not shown). Here, as the oxidant, air is used. Additionally, a supply of cooling water is provided through the manifold apertures 23 of the separators 3A, 3B and through the cooling water flow path 28 of the cooling plate 15 from a cooling water supply line (not shown).

In the fuel electrode 12A, the organic fuel supplied passes through the diffusion layer 51A and reaches the catalysis layer 52A in which a hydrogen ion 111, an electron 110, and CO₂ gas are generated by the action of the catalyst 101. In other words, in the fuel electrode 12A, the organic fuel supplied undergoes an oxidation to generate CO₂ gas. The electron 110 passes through an externally connected circuit 112 and arrives at the oxidant electrode 12B. Hereby, electric current flows. On the other hand, the hydrogen ion 111 moves inside the hydrogen ion-conductive polyelectrolyte membrane 11 and reaches the oxidant electrode 12B. In the oxidant electrode 12B, by virtue of the action of the catalyst 101, the electron 110 and the hydrogen ion 111 from the fuel electrode 12A react with oxygen supplied from the outside to generate water. Therefore, in the entire fuel cell reactions take place, by which water and CO₂ are generated from the organic fuel and oxygen, and electricity is produced at the time of the reactions. Theoretically, fuel cells employing an organic fuel generate greater electricity in comparison with fuel cells employing hydrogen. Moreover, in a fuel cell system using an organic fuel, the organic fuel can be supplied directly to the fuel cell, thereby eliminating the need for the provision of a hydrogen generator or the like. This achieves system downsizing.

Here, in the above-described reaction taking place in the fuel electrode 12A, the organic fuel is not oxidized into CO₂ in one step. As a result, a CO compound is generated, which is a product in an intermediate process of the oxidation. Such a chemical compound is adsorbed on the surface of the catalyst 101 in the catalysis layer 52A of the fuel electrode 12A. Here, in the present embodiment, since the catalysis layer 52A contains, as a constituent component, the carbon monoxide oxidizer 104, the CO compound adsorbed onto the catalyst 101 is oxidized by the carbon monoxide oxidizer 104, is converted into CO₂, and is desorbed from the catalyst 101. Accordingly, it becomes possible to effectively prevent the CO compound from poisoning the catalyst 101.

Additionally, in the catalysis layer 52A of the fuel electrode 12A according to the present embodiment, the kind of material and the ratio of the catalyst 101, the electrically conductive substance 102, the hydrogen ion-conducting electrolyte substance, and the carbon monoxide oxidizer 104 are set respectively so that the organic fuel supply pathway and CO₂ discharge pathway formed by the fine pores 103A in the reaction layer 52A; the hydrogen ion-conduction pathway formed by the hydrogen ion-conductive polyelectrolyte substance which is a constituent component of the catalysis layer 52A; and the electron-conduction pathway formed by the electrically conductive substance 102 which is a constituent component of the reaction layer 52A are all adequately secured for the achievement of effective substance movement and oxidation in these pathways, and, in addition, so that oxidation of a CO compound is effectively carried out by adequately ensuring the area of contact between the carbon monoxide oxidizer 104 and the CO compound. Therefore, in the fuel cell provided with the fuel electrode 12A described above, oxidation of the organic fuel is carried out stably and efficiently, and satisfactory electricity generation is achieved efficiently.

In the above, the description has been made in terms of the case where the catalyst 101 is supported on the electrically conductive substance 102 in the catalysis layer 52A. Alternatively, the catalyst 101 may be so arranged as to be unsupported. Even in this case, the same effects as described above are obtained by mixing, at adequate weight ratios, a catalyst, a hydrogen ion-conductive polyelectrolyte substance, and a carbon monoxide oxidizer. For example, in the case of employing a catalyst of the non-support type, the M/P ratio is preferably between about 0.01 and 0.3, where M represents the weight of the carbon monoxide oxidizer and P represents the weight of the catalyst.

The invention will now be described in more detail with reference to the following specific, non-limiting Examples.

### General Production and Testing Procedure Example

Hereinafter, an example of the present invention will be explained concretely. In the example, the MEA 1 as shown in FIG. 2 was first prepared, and the fuel-cell cell unit 10 as shown in FIG. 1 was prepared using the MEA 1. Then, a plurality of fuel-cell cell units 10 were laminated together to form the fuel cell stack 200 of FIG. 3. Using such fuel cell stacks 200 thus prepared, fuel-cell voltage measurements were performed on the following Examples as well as on comparative examples.

During preparation of the MEA 1, the catalysis layer 52A of the fuel electrode 12A was formed over one entire surface (except for its edge areas) of the hydrogen ion-conductive polyelectrolyte membrane (Nafion® 117, product of DuPont and hereinafter called “Nafion® membrane”) 11 which is an 8 cm by 8 cm square, while the catalysis layer 52B of the oxidant electrode 12B was formed over the other entire surface of the Nafion® membrane 11 except for its edge areas. Here, each of the catalysis layers 52A, 52B was shaped as a 5 cm by 5 cm square. Then, as the diffusion layers 51A, 51B, either a carbon woven cloth (GF-20-31E, product of Nippon Carbon Co., Ltd.) or a carbon non-woven cloth (TGPH060, product of Toray Industries, Inc.) was disposed upon the outer surface of each of the catalysis layers 52A, 52B, and these layers were superimposed with the Nafion® membrane 11 placed centrally and joined together at their edges by means of a hot pressing technique. In the case of using a carbon woven cloth, the pressing temperature was 140° C., the pressing pressure was 20 kgf/cm², and the pressing time was 15 minutes. On the other hand, in the case of using a carbon non-woven cloth, the pressing temperature was 150° C., the pressing pressure was 15 kgf/cm², and the pressing time was 30 minutes. In the manner described hereinabove, the MEA 1, formed by combining the electrodes (the fuel and oxidant electrodes 12A, 12B) constituted by the catalysis layers 52A, 52B and the diffusion layers 51A, 51B and the Nafion® membrane 11, was prepared.

The catalysis layer 52A of the fuel electrode 12A was formed as follows. First, platinum and ruthenium particles having an average particle size of about 30 Å and constituting the catalyst 101 were respectively supported at 25% by weight on the conductive carbon particles 102 (more specifically, Ketjen Black® EC, a carbon black product of Ketjen Black International) having an average primary particle size of 30 nm, to prepare catalyst support particles A. Next, a catalysis layer material was prepared by mixing the catalyst support particles A, electrically conductive particle perfluorocarbon sulfonic acid (Flemion®, product of Asahi Glass Co., Ltd., and hereinafter called “Flemion®”) which is a hydrogen ion-conductive polyelectrolyte substance, and a carbon monoxide oxidizer used in each of the following Examples by the respective methods of the Examples described later. Then, the catalysis layer 52A was formed on one surface of the Nafion® membrane 11 by using the catalysis layer materials by the respective methods of the following Examples. In the catalysis layer 52A thus formed, the ratio of the weight C of the electrically conductive carbon particles (Ketjen Black® EC) contained in the catalyst support particles A to the weight F of the hydrogen ion-conductive polyelectrolyte substance (Flemion®), i.e., the F/C ratio, was set to respective values shown in the following Examples. Additionally, the ratio of the weight C of the electrically conductive carbon particles (Ketjen Black® EC) contained in the catalyst support particles A to the weight M of the carbon monoxide oxidizer, i.e., the M/C ratio, was set to respective values shown in the following Examples.

On the other hand, the catalysis layer 52B of the oxidant electrode 12B was formed by the following method. First, platinum particles having an average particle size of about 30 Å and constituting the catalyst 101 were supported at 50% by weight on Ketjen Black® EC, to prepare catalyst support particles B. Next, the catalyst support particles B were mixed with Flemion® to prepare a paste-like catalysis layer material. Then, the catalysis layer material was printed onto the other surface of the Nafion® membrane 11 to form the catalysis layer 52B. In the catalysis layer 52B thus formed, the ratio of the weight C of the electrically conductive carbon particles (Ketjen Black® EC) contained in the catalyst support particles B to the weight F of the hydrogen ion-conductive polyelectrolyte substance (Flemion®), i.e., the F/C ratio, was 1.0.

Furthermore, in preparation of the fuel cell, a gasket plate 2 of rubber was joined to the outer periphery of the MEA 1 prepared according to the forgoing method (the edge of the Nafion® membrane 11), and the manifold apertures 23, 24 were formed through the gasket plate 2. The two separators 3A, 3B were provided, each composed of a graphite plate impregnated with resin, having an outer size of 10 cm by 10 cm and a thickness of 1.3 mm, and provided with 0.5 mm-deep grooves serving as the fuel flow paths 26 or as the oxidant flow paths 27 on a surface thereof. The separator 3A provided with the fuel flow paths 26 was disposed so that the flow paths 26 were situated face to face with one surface of the MEA 1. On the other hand, the separator 3B provided with the oxidant flow paths 27 was disposed so that the flow paths 27 were situated face to face with the other surface of the MEA 1. A current collecting plate made of stainless steel with its surface gold-plated and an insulating plate composed of an electrical insulating material were provided at both ends of the pair of the separators 3A, 3B, which were placed one upon the other with the MEA 1 sandwiched therebetween and end plates and fastening rods were used for fixing. The fastening pressure at this time was 15 kgf/cm² of separator area. In the manner described above, the cell unit 10 as an electric cell was prepared.

Furthermore, a cooling plate 15 provided with a 0.5 mm-deep groove serving as the cooling water flow path 28 was interposed between a pair of cell units 10 prepared in the above-described manner to form a stack construction unit 40, and five stack construction units 40 were laminated one upon the other to form a fuel cell stack 200 made up of a total of ten cell units 10. A current collecting plate made of stainless steel with its surface gold-plated and an electric insulating plate were disposed on both ends of the fuel cell stack 200, and end plates and fastening rods were used for fixing. The fastening pressure at this time was 15 kgf/cm² of separator area.

Discharge testing in each of the following Examples, using a fuel cell stack having the above-described construction, was carried out by the following methods. Namely, a water solution of methanol (temperature: 60° C.; concentration: 2 mol/l) was supplied as a fuel to the fuel supply electrode side of the fuel cell stack 200 and, at the same time, air was supplied as an oxidant to the oxidant electrode side of the fuel cell stack 200 through a bubbler of 60° C. at an air utilization ratio (Uo) of 30% while maintaining the fuel cell stack temperature at 60° C. At this time, pressure was applied so that the pressure at the air side outlet was 2 atm. The fuel cell was operated by such supply of fuel and air to generate electric energy, and the voltage at electric energy generation time was measured.

### EXAMPLE 1

In the first example, the catalysis layer 52A of the fuel electrode 12A was formed for preparation of the fuel cell 1 by the following method. Namely, at the time of forming the catalysis layer 52A of the fuel electrode 12A of the fuel cell 1, the foregoing catalyst support particles A and Flemion®0 were mixed together to prepare a catalyst paste. Then, manganese dioxide was added to the catalyst paste as a carbon monoxide oxidizer and dispersed by ultrasonic waves. As the manganese dioxide, Dennman® FMH, product of Tosoh Corporation, in the form of pulverized particles having an average particle size of 300 nm was used. Here, the ratio of the weight of the electrically conductive carbon particle contained in the catalyst support particles A to the weight of the hydrogen ion-conductive polyelectrolyte substance, i.e., the F/C ratio, was 1.0. Additionally, the ratio of the weight of the electrically conductive carbon particles contained in the catalyst support particles A to the weight of the manganese dioxide, i.e., the M/C ratio, was 0.1. The catalyst paste thus prepared was printed onto a surface of the Nafion® membrane 11 to form the catalysis layer 52A of the fuel electrode 12A. In this case, the amount of platinum catalyst in the catalysis layer 52A was 1.84 mgPt/cm². On the other hand, the amount of platinum catalyst in the catalysis layer 52B of the oxidant electrode 12B formed by the aforesaid method was 1.40 mgPt/cm².

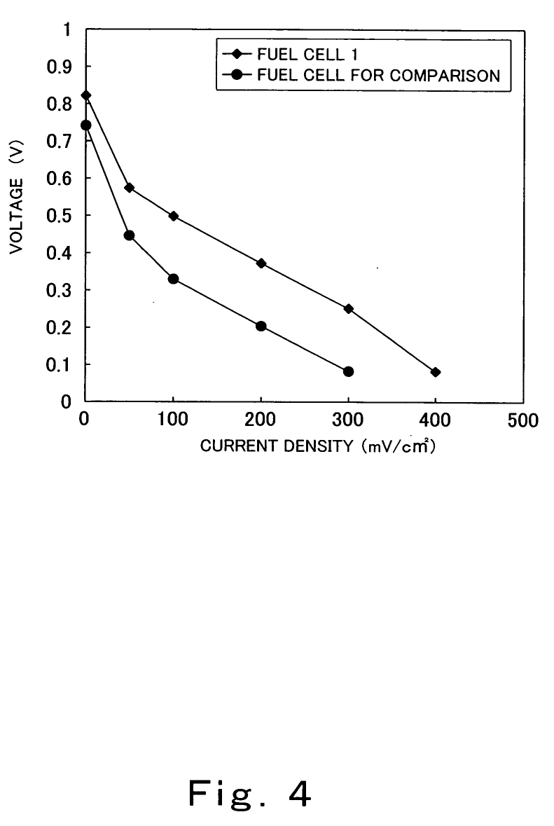

The discharge characteristics of the above-described fuel cell 1 were examined. The results of the examination showed that the voltage of a unit cell (electric cell) of the fuel cell 1 at a current density of 200 mA/cm² was 0.374 V. Additionally, the voltage measurements were carried out while making variations in current density, and FIG. 4 shows the results. The measurement result of a unit cell (electric cell) showed here was obtained by dividing the actually measured voltage of the fuel cell stack 200 by the number of cells for converting into a unit cell.

On the other hand, for the purpose of comparison, a fuel cell identical in structure with the fuel cell 1 with the exception that the catalysis layer 52A of the fuel electrode 12A contained no manganese dioxide therein, that is a fuel cell in which the catalysis layer 52A of the fuel electrode 12A contained no carbon monoxide oxidizer (hereinafter called “comparative fuel cell” or “fuel cell for comparison” (in the Figs.)), was prepared. The discharge characteristics of the comparative fuel cell were examined in the same way that the fuel cell 1 was examined. The results of the examination showed that the voltage of a unit cell (electric cell) of the comparative fuel cell at a current density of 200 mA/cm² was 0.201 V. Additionally, the voltage measurements were carried out while making variations in current density, and FIG. 4 shows the results.

From the above results, it is clear that the arrangement where the catalysis layer 52A of the fuel electrode 12A contains manganese dioxide as a carbon monoxide oxidizer contributes to improvement in fuel cell voltage.

### EXAMPLE 2

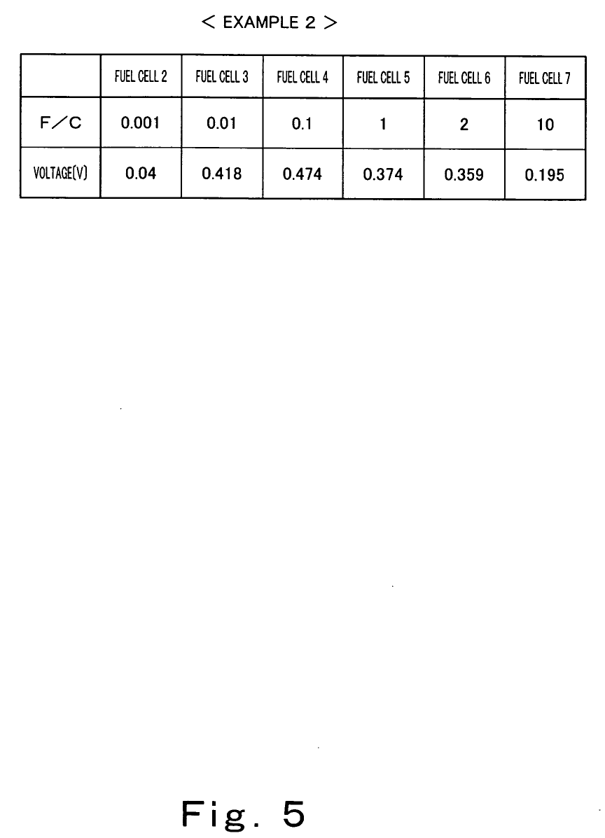

In the second example, fuel cells 2-7 were prepared, each having a different F/C ratio from the other in the catalysis layer 52A of the fuel electrode 12A. The discharge characteristics of each of the fuel cells 2-7 were examined to find out the relationship between the F/C ratio and the fuel cell voltage. These fuel cells 2-7 were prepared in the same way that the fuel cell 1 of Example 1 was made, with the exception that each catalyst paste was prepared such that the ratio (F/C) of the weight F of Flemion® as a hydrogen ion-conductive polyelectrolyte substance to the weight C of Ketjen Black® EC as electrically conductive carbon particles contained in the catalyst support particles A assumed the respective values shown in FIG. 5. Additionally, the voltage of each of the fuel cells 2-7 was measured in the same way that the voltage of the fuel cell 1 of Example 1 was measured.

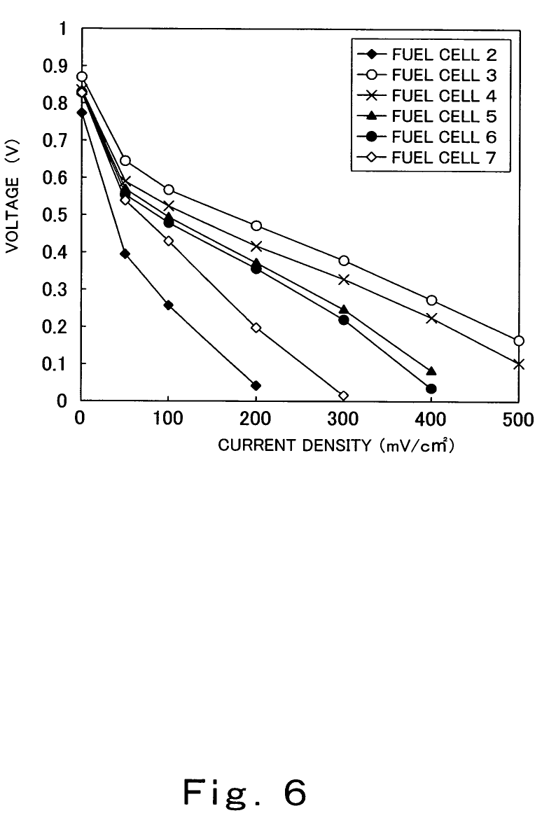

Referring to FIG. 5, there are shown the results of the voltage measurement of a unit cell (electric cell) of each fuel cell 2-7 at a current density of 200 mA/cm². The voltage measurements were carried out while making variations in electric current density in each fuel cell 2-7, and FIG. 6 shows the results. It is clear from the results that preferably the F/C ratio ranges between about 0.01 and 2. The reason is that if the F/C ratio falls within such a range, it is conceivable that the total area of the three-phase interface of the fuel flow path, the hydrogen ion-conduction pathway, and the electron conduction pathway increases in the catalysis layer 52A of the fuel electrode 12A, thereby achieving improvement in oxidation efficiency and improvement in the voltage generated by the fuel cell.

### EXAMPLE 3

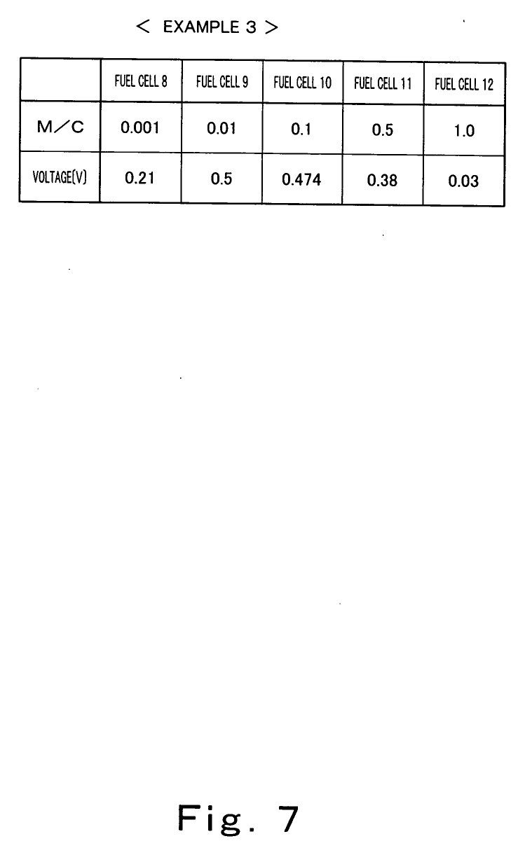

In the third example, fuel cells 8-12 were prepared, each having a different M/C ratio from the other in the catalysis layer 52A of the fuel electrode 12A. The discharge characteristics of each of the fuel cells 8-12 were examined to find out the relationship between the M/C ratio and the fuel cell voltage. These fuel cells 8-12 were prepared in the same way that the fuel cell 1 of Example 1 was made, with the exception that each catalyst paste was prepared such that the ratio (M/C) of the weight M of the manganese dioxide as a carbon monoxide oxidizer to the weight C of Ketjen Black® EC as electrically conductive carbon particles contained in the catalyst support particles A assumed the respective values shown in FIG. 7, and that the F/C ratio was 0.1. Additionally, the voltage of each fuel cell 8-12 was measured in the same way as the voltage of the fuel cell 1 of Example 1 was measured.

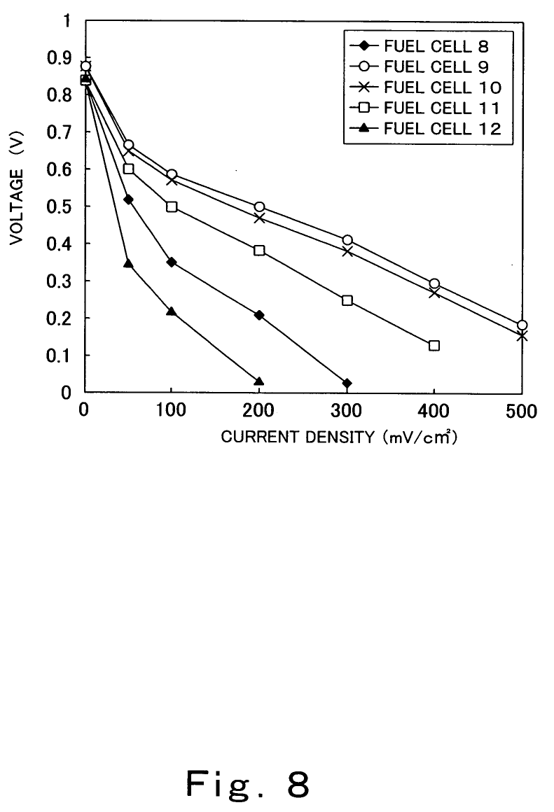

Referring to FIG. 7, there are shown the results of the voltage measurement of a unit cell (electric cell) of each fuel cell 8-12 at a current density of 200 mA/cm². The voltage measurements were carried out while making variations in electric current density in each fuel cell 8-12, and FIG. 8 shows the results. It is clear from the results that preferably the M/C ratio ranges between about 0.01 and 0.5. The reason is that if the M/C ratio falls within such a range, it is conceivable that the drop in catalyst reactivity and the drop in electron conductivity are prevented at the same time in the catalysis layer 52A of the fuel electrode 12A, thereby achieving improvement in the voltage generated by the fuel cell.

### EXAMPLE 4

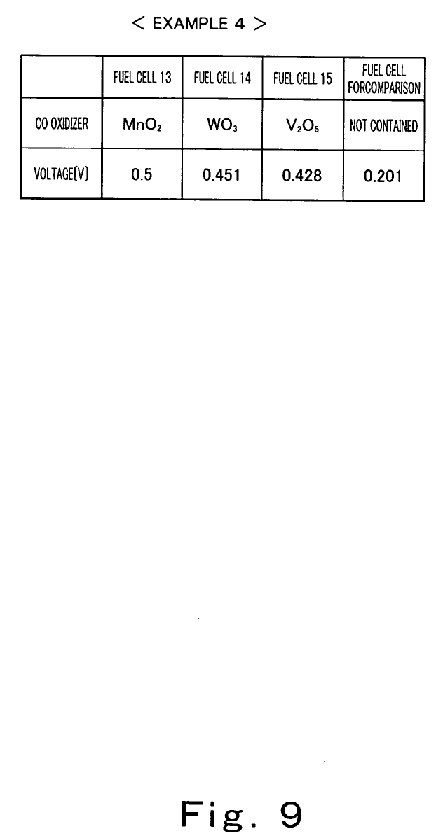

In the fourth example, fuel cells 13-15 were prepared, each containing a type of carbon monoxide oxidizer in the catalysis layer 52A of the fuel electrode 12A different from the other. The discharge characteristics of each of the fuel cells 13-15 were examined to find out the relationship between the type of carbon monoxide oxidizer and the fuel cell voltage. The fuel cells 13-15 were prepared in the same way that the fuel cell 1 of Example 1 was prepared, with the exception that MnO₂-based manganese oxides, WO₃-based tungsten oxides, and V₂O₅-based vanadium oxides were used to prepare a catalyst paste, and that the F/C ratio and the M/C ratio were 0.1 and 0.01 respectively in the catalyst paste (see FIG. 9). Additionally, the voltage of each fuel cell 13-15 was measured in the same way that the voltage of the fuel cell 1 of Example 1 was measured.

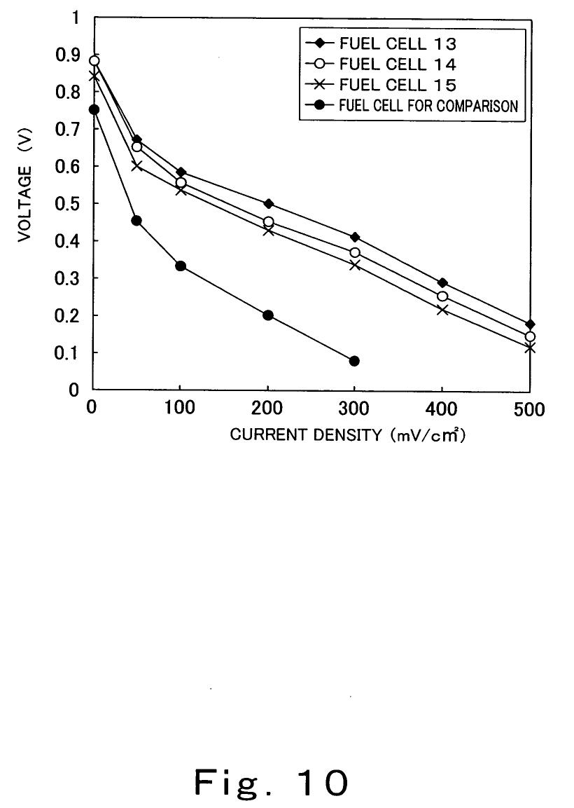

Referring to FIG. 9, there are shown the results of the voltage measurement of a unit cell (electric cell) of each fuel cell 13-15 at a current density of 200 mA/cm². The voltage measurements were carried out while making variations in current density, and FIG. 10 shows the results. In FIGS. 9 and 10 there are shown the results of the comparative fuel cell of Example 1 for the sake of comparison. It is clear from the results that, in addition to manganese oxides, oxides of tungsten and vanadium were also effective as the carbon monoxide oxidizer contained in the catalysis layer 52A of the fuel electrode 12A.

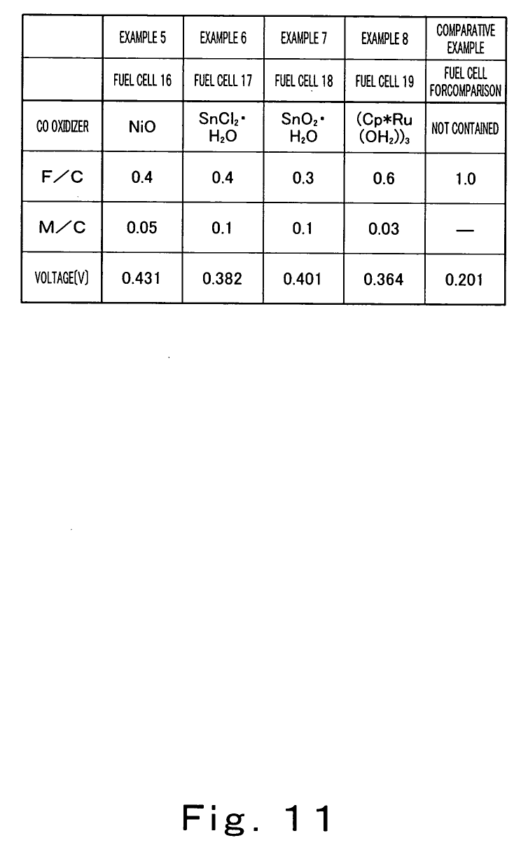

In the following examples 5-8, as shown in FIG. 11, fuel cells 16-19, each containing a type of carbon monoxide oxidizer in the catalysis layer 52A of the fuel electrode 12A different from the other, were prepared using different methods. The discharge characteristics of each fuel cell 16-19 were examined in the same way that the discharge characteristics of the fuel cell 1 of Example 1 was examined. Hereinafter, the method of forming the catalysis layer 52A of the fuel electrode 12A in each of Examples 5-8 will be described in detail.

### EXAMPLE 5

In the fifth example, in formation of the catalysis layer 52A of the fuel electrode 12A, pre-ground nickel oxide particles having an average particle size of 3 μm were added to the foregoing catalyst support particles A as a carbon monoxide oxidizer. Thereafter, these particles were dry mixed together. The catalyst support powders thus mixed were dispersed in a 5% isopropanol in water solution, and then a Flemion® solution serving as a hydrogen ion-conductive polyelectrolyte solution was added thereto to prepare a catalyst paste. In the catalyst paste thus blended, the F/C ratio was 0.4 and the M/C ratio was 0.05.

The catalyst paste described above was printed onto a surface of the Nafion® membrane 11 to form the catalysis layer 52A, as in Example 1. The amount of platinum catalyst of the catalysis layer 52A thus formed was 1.85 mgPt/cm². On the other hand, the catalysis layer 52B of the oxidant electrode 12B was formed in accordance with the foregoing method, with the exception that the catalyst paste was prepared by dispersing the aforesaid catalyst support particles B in a 5% isopropanol in water solution and, thereafter, by addition of a Flemion® solution thereto. The amount of platinum catalyst of the catalysis layer 52B of the oxidant electrode 12B was 1.38 mgPt/cm². In the manner described above, the fuel cell 16 was prepared.

### EXAMPLE 6

In the sixth example, in formation of the catalysis layer 52A of the fuel electrode 12A, the aforesaid catalyst support particles A were dispersed in ion exchange water and slurried therewith. Then, a 0.5% methanol in water solution with SnCl₂•H₂O serving as a CO oxidizer dissolved therein, was added dropwise to the slurry. The slurry thus prepared was filtered and baked at 200° C. in an atmosphere of nitrogen. The slurry thus baked was ground to catalyst powders. Here, observations of images by TEM were made by using a part of the catalysis layer material powders. The results showed that the average primary particle sizes of carbon black, platinum-ruthenium alloy, and SnCl₂ were 30 nm, 3 nm, and 100 nm, respectively. It was observed that SnCl₂ was present mainly on the carbon black.

The aforesaid catalyst material powders were dispersed in a solution of isopropanol:water=1:1, and Flemion® was added thereto to prepare a catalyst paste. Then, this catalyst paste was printed 50 μm thick onto a Teflon sheet with a doctor blade, and the Teflon sheet was dried for 5 hours at room temperature in an atmosphere of nitrogen. After the drying step, the sheet on which the catalysis layer 52A had been printed was cut away into a predetermined size. Such a cut-away sheet portion was thermally transferred onto the Nafion® membrane 11, so that its catalysis layer printing surface was positioned on a surface of the membrane. During such thermal transferring, a printed Teflon sheet was positioned on each surface of the Nafion® membrane 11 disposed therebetween with the printed surfaces located inside, and the Teflon sheets and the Nafion® membrane 11 were joined together by hot pressing with the Nafion® membrane 11 held tight between the catalysis layers 52A. In this pressing step, a pressure of 20 kgf/cm² was applied at 130° C. for 15 minutes. After the joining step, the Teflon sheets were removed, and a 180 μm-thick carbon non-woven cloth (TGPH060, product of Toray Industries, Inc.) was joined to the surface of the catalysis layer 52A by hot pressing to form the diffusion layer 51A. In this pressing step, a pressure of 15 kgf/cm² was applied at 150° C. for 30 minutes.

In order to measure the ratio of weight of each component of the catalysis layer 52A formed in the manner described above, the catalyst paste was applied onto a copper foil and the ratio of Pt to Sn was measured by XPS. The results showed that the Pt/Sn ratio was 75:25 and the Pt/Sn weight ratio in the catalysis layer 52A was 50:10. Here, the ratio of supporting Pt in the catalyst support particles A is 25%, as described above. Therefore, the M/C ratio in the catalysis layer 52A is 0.1. Additionally, the F/C ratio of the catalysis layer 52A was 0.4, and the amount of platinum catalyst in the catalysis layer 52A was 1.80 mgPt/cm². On the other hand, the catalysis layer 52B of the oxidant electrode 12B was formed in the same way that the catalysis layer 52A of the fuel electrode 12A was formed, with the exception that the catalyst support particles B were used. The amount of platinum catalyst in the catalysis layer 52B of the oxidant electrode 12B was 1.41 mgPt/cm². In the manner described hereinabove, the electrodes 12A, 12B were formed and the fuel cell 17 was prepared.

### EXAMPLE 7

In the seventh example, in formation of the catalysis layer 52A of the fuel electrode 12A, the aforesaid catalyst support particles A were dispersed in ion exchange water and were slurried therewith. Then, a 0.5% methanol in water solution with SnO₂•H₂O dissolved therein was added dropwise to the slurry. The slurry was stirred. This was followed by dropwise addition of a 5% aqueous solution of NaOH to the slurry. Thereafter, the slurry was stirred with an ultrasonic homogenizer. After filtering, cleaning was carried out five times with ion exchange water. The resulting solid substance was dried at 100° C. by an oven and, thereafter, was ground to catalysis layer material powders. Here, observations of images by TEM were made using a part of the catalysis layer material powders. The results showed that the average primary particle sizes of carbon black, platinum-ruthenium alloy, and SnO₂ were 30 nm, 3 nm, and 30 nm, respectively and that SnO₂ was present mainly on the platinum-ruthenium alloy.

With the use of the catalysis layer material powders thus prepared, the catalysis layer 52A was formed employing the same technique as in Example 6. In order to measure the ratio of weight of each component of the catalysis layer 52A, the Pt/Sn ratio was measured using the same method as in Example 6. The results showed that the Pt/Sn weight ratio was 75:25 and the Pt/Sn weight ratio in the catalysis layer 52A was 50:10. Here, the ratio of supporting Pt in the catalyst support particles A is 25%, as described above. Therefore, the M/C ratio in the catalysis layer 52A is 0.1. Additionally, the F/C ratio of the catalysis layer 52A was 0.3, and the amount of platinum catalyst of the catalysis layer 52A was 1.80 mgPt/cm². On the other hand, the catalysis layer 52B of the oxidant electrode 12B was formed in the same way that the catalysis layer 52A was formed, with the exception that the catalyst support particles B were used. The amount of platinum catalyst contained in the catalysis layer 52B of the oxidant electrode 12B was 1.41 mgPt/cm². In the manner described hereinabove, the electrodes 12A, 12B were formed, and the fuel cell 18 was prepared.

### EXAMPLE 8

In the eighth example, in formation of the catalysis layer 52A of the fuel electrode 12A, the catalyst support particles A were dispersed in water to form a catalyst paste. The catalyst paste was doped with a 10 wt % aqueous solution of a carbon monoxide oxidizer prepared by dissolving a trihydrate pentamethylcyclopentadienyl ruthenium complex (Cp*Ru(OH₂)₃) in ion exchange water. The catalyst paste thus prepared was heated and stirred at 50° C. for 8 hours. Thereafter, the catalyst paste was cooled to room temperature. Then, Flemion® was added to the catalyst paste, and the resulting substance was stirred overnight. In the catalyst paste thus obtained, the F/C ratio was 0.6 and the M/C ratio was 0.03. Next, the catalyst paste was applied onto a surface of the Nafion® membrane 11, and a sheet of carbon paper (TGPH090, product of Toray Industries, Inc.) was positioned on an outer surface of the catalyst paste and was joined thereto by hot pressing to form the fuel electrode 12A. The amount of platinum catalyst contained in the catalysis layer 52A was 1.83 mgPt/cm². On the other hand, the catalysis layer 52B of the oxidant electrode 12B was formed in the same manner that the catalysis layer 52A was formed, with the exception that the catalyst paste was prepared by addition of Flemion® into water in which the catalyst support particles B were dispersed. The amount of platinum catalyst contained in the catalysis layer 52B was 1.40 mgPt/cm². In the manner described hereinabove, the electrodes 12A, 12B were formed, and the fuel cell 19 was prepared.

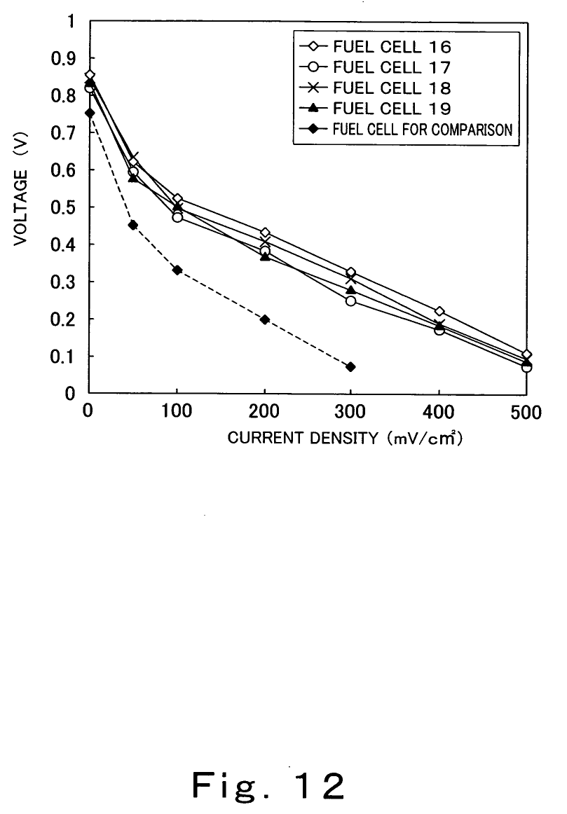

The discharge characteristics of each of the fuel cells 16-19 of Examples 5-8 were examined, and the results are discussed here. Referring to FIG. 11, there are shown the results of the voltage measurement of a unit cell (electric cell) of each of the fuel cells 16-19 at a current density of 200 mA/cm². The voltage measurements were carried out while making variations in current density in each fuel cell 16-19 and FIG. 12 shows the results. Here, there are also shown the results of the comparative fuel cell of Example 1 for the sake of comparison. As can be seen from FIGS. 11 and 12, it is clear that, in the fuel cells 16-19 formed by the aforesaid various methods and provided with the catalysis layers 52A containing different carbon monoxide oxidizers, their fuel cell voltage is improved.

In Examples 1-8, methanol is fed, as an organic fuel, to the fuel cell. Also, in the cases where other organic fuels (such as ethanol, ethylene glycol, dimethylethane, dimethoxyethane, etc. and mixtures thereof) are used, the same effects as obtained by using methanol were obtained. In addition to supplying such organic fuels in the form of a liquid, they may be evaporated beforehand and be supplied in the form of a vapor. Furthermore, in Examples 1-8 the diffusion layers 51A, 51B of the electrodes were formed using electrically conductive carbon particle paper and carbon non-woven cloth. However, the diffusion layers 51A, 51B may be formed using other than these materials. For example, other electrically conductive carbon black particles, electrically conductive carbon particle cloths, metal meshes, etc. may be used. Also, in these cases, the same effects are obtained.

### INDUSTRIAL APPLICABILITY

The present invention provides fuel cells suited for use as polyelectrolyte type fuel cells of the type in which an organic fuel is supplied, as a fuel, directly to the fuel electrode, e.g., polyelectrolyte type fuel cells used in household cogeneration systems. Additionally, the application of a joined structure (MEA) of a solid polyelectrolyte and electrodes according to the present invention is not limited to the above. The MEA of the present invention can be applied to various sensors, such as alcohol sensors.

Numerous modifications and alternative embodiments of the invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the sprit of the invention, and all modifications which come within the scope of the appended claims are reserved.

1. A fuel cell comprising a hydrogen ion-conductive electrolyte membrane, a first electrode disposed on one surface of the hydrogen ion-conductive electrolyte membrane, a second electrode disposed on a second surface of the hydrogen ion-conductive electrolyte membrane, wherein the first and second electrodes include respective catalysis parts, wherein a fuel is supplied to the first electrode and an oxidant is supplied to the second electrode, and wherein electricity is produced by oxidation of the fuel,
the catalysis part of at least the first electrode comprising:
a catalyst which participates in the fuel oxidation,
an electrically conductive substance which constitutes a pathway for electrons generated by the fuel oxidation,
a hydrogen ion-conductive electrolyte substance which constitutes a pathway for hydrogen ions generated by the fuel oxidation, and
a granular carbon monoxide oxidizer for oxidizing a CO compound generated in the fuel oxidation.

2. The fuel cell as set forth in claim 1, wherein the catalyst comprises at least one metal element selected from the group consisting of platinum, ruthenium, palladium, nickel, rhodium, cobalt, iridium, osmium, iron, and mixtures thereof.

3. The fuel cell as set forth in claim 2, wherein the catalyst is in a form selected from the group consisting of simple metal substances, metal compounds, and alloys.

4. The fuel cell as set forth in claim 1, wherein the electrically conductive substance comprises a substance selected from the group consisting of carbon black, carbon particles, metal fine particles, electrically conductive polymers, and mixtures thereof.

5. The fuel cell as set forth in claim 1, wherein the hydrogen ion-conductive electrolyte substance comprises a polyelectrolyte substance.

6. The fuel cell as set forth in claim 5, wherein the hydrogen ion-conductive electrolyte substance contains a fluorocarbon in its main chain.

7. The fuel cell as set forth in claim 1, wherein the carbon monoxide oxidizer comprises a substance selected from the group consisting of simple metal compounds, metal compounds having hydrated water, organic substances, metal complexes containing water as a ligand, and mixtures thereof.

8. The fuel cell as set forth in claim 7, wherein the simple metal compound is selected from the group consisting of metal oxides, metal chlorides, metal hydrides, and mixtures thereof.

9. The fuel cell as set forth in claim 8, wherein the metal oxide is partially crystalline.

10. The fuel cell as set forth in claim 8, wherein the metal oxide is entirely crystalline.

11. The fuel cell as set forth in claim 1, wherein the carbon monoxide oxidizer overlies the electrically conductive substance.

12. The fuel cell as set forth in claim 1, wherein the carbon monoxide oxidizer overlies the catalyst.

13. The fuel cell as set forth in claim 1, wherein the carbon monoxide oxidizer comprises a mixture with the catalyst.

14. The fuel cell as set forth in claim 1, wherein the carbon monoxide oxidizer has a particle size of not less than about one time nor more than about 100 times a particle size of the catalyst.

15. The fuel cell as set forth in claim 1, wherein an F/C ratio is not less than about 0.01 nor more than about 2, where F denotes a weight of the hydrogen ion-conductive electrolyte substance and C denotes a weight of the electrically conductive substance.

16. The fuel cell as set forth in claim 1, wherein an M/C ratio is not less than about 0.01 nor more than about 0.5, where M denotes a weight of the carbon monoxide oxidizer and C denotes a weight of the electrically conductive substance.

17. The fuel cell as set forth in claim 1, wherein the fuel comprises an organic compound.

18. The fuel cell as set forth in claim 17, wherein the organic compound is selected from the group consisting of methanol, ethanol, ethylene glycol, dimethylether, dimethoxymethane, and mixtures thereof.
